(19) United States
(12) Patent Application Publication
(10) Pub. No.: US 2026/0087251 A1
(43) Pub. Date: Mar. 26, 2026

(54) METHOD FOR GENERATING A REQUEST TO A DATABASE

(71) Applicant: ARTEM ALEKSANDROVICH KRAVCHENKO, Moscow (RU)

(72) Inventor: ARTEM ALEKSANDROVICH KRAVCHENKO, Moscow (RU)

(21) Appl. No.: 18/905,408

(22) Filed: Oct. 3, 2024

(30) Foreign Application Priority Data
Sep. 21, 2024 (RU) 2024127897

(51) Int. Cl. G06F 40/279; G06F 16/334; G06F 40/211; G06F 40/30

(52) U.S. Cl. CPC G06F 40/279; G06F 16/3344; G06F 40/211; G06F 40/30

(57) ABSTRACT

The proposed technical solution relates to methods of automated text processing and can be used in the generating of text corpuses. The technical problem solved by the claimed invention is the creation of a method and/or a computer device and/or a system and/or a machine-readable data carrier that do not have the disadvantages of analogs and thus ensure accurate automated generation of a text corpus, which can subsequently be used for pre-training, or training, or additional training of classification models and/or clustering models.

### FIELD OF INVENTION

The claimed technical solution relates to methods of automated text processing and can be used to form text corpus.

### BACKGROUND OF INVENTION

Various automated methods to create texts in natural languages are known in prior art, for example: US20070136321A1 dated Jun. 14, 2007, US20100205125A1 dated Aug. 12, 2020, US20190377780A1 dated Dec. 12, 2019, US20130080883A1 dated Mar. 28, 2013, U.S. Pat. No. 10,713,443B1 dated Jul. 14, 2020, U.S. Pat. No. 10,747,953B1 dated Aug. 18, 2020, U.S. Pat. No. 11,023,662B2 dated Jun. 1, 2021, and U.S. Pat. No. 11,341,323B1 dated May 24, 2022. However, known solutions do not allow creating texts in natural languages with sufficient completeness specific to a particular area, for example, patent documents. Patent documents not only require the actual formation of disclosures, but it is also necessary to form other parts of a patent document, for example, the Background of the Invention. To do that, in most cases, a statement is required in the form of disclosure of the technical problem solved by the invention or the technical result achieved by using the invention (technical effect (9.2.8 Case Law of the Boards of Appeal), (technical) result (MPEP 716.02(a))).

U.S. Pat. No. 11,593,564B2 dated Feb. 28, 2023 (D1) describes systems, methods and media for extracting templates of patent documents from the patent corpus. The above-mentioned patent is implemented as follows: a patent corpus is obtained; one or more parameters are identified; one or more subsets of the patent corpus are determined by filtering the patent corpus based on one or more parameters; one or more clusters of documents are identified from one or more subsets of the patent corpus; a patent document template corresponding to the first cluster of documents is obtained; and/or other operations are performed. However, the solution known from D1 does not disclose any extraction methods for, in particular, statements concerning the technical result.

U.S. Pat. No. 5,774,833A dated Jun. 30, 1998 (D2) describes a method for processing patent text on a computer, including determining the boundaries of the patent text parts, loading at least one of the parts into working memory, analyzing at least one of the parts and communicating the results to the user. Moreover, the alphanumeric data of the drawing can be compared with the patent text. The D2 method can be combined with a word processor program. The D2 method allows recognizing and report dependence of claims, specific characteristics of the patent text and patent errors based on legal standards, standards of practice and USPTO, or even user preferences. However, the solution known from D2 does not disclose any extraction methods for, in particular, statements concerning the technical result.

Thus, there is a problem of automated extraction of statements from specific natural language texts, such as, but not limited to, patent documents.

The solution known from D2 can be described as the closest analog.

### SUMMARY OF THE INVENTION

The technical problem solved by the claimed invention involves the creation of a method, and/or a computer device, and/or a system, and/or a machine-readable data carrier that does not have the disadvantages of analogs, and thus provides accurate automated text corpus, which can subsequently be used for pre-training, training, or retraining of classification models and/or clustering models.

The technical result consists in eliminating the disadvantages of analogs and thus ensuring the accurate automated formation of text corpus, which can subsequently be used for pre-training, training, or retraining of classification models and/or clustering models. Another technical result is the expansion of technical means for automated text processing in natural languages.

The technical result is achieved by implementing a method for generating a request to a database, the method executed by a processor of a computer device, the method for generating a request to a database comprising: forming the request to the database containing at least one statement obtained using a method of forming a text corpus, wherein the database contains at least a plurality of parsed texts, each associated with one or more of said statements, wherein the plurality of parsed texts being obtained using a method executed by a processor of a computer device, the method comprising: obtaining a plurality pairs of texts using a method of automated processing of natural language text, wherein each pair includes at least one statement associated with a main entity of a first segment, and forming the text corpus from the resulting pairs of texts; wherein the method of automated processing of natural language text being executed by a processor of a computer device, the method of automated processing of natural language text comprising at least the following steps: a step 101 of identification of a natural language text with at least three segments; identification of segments; a step 102 of selecting of at least the first segment and at least a second segment and/or at least a third segment of the natural language text; a step 103 of marking up of only one part to be parsed in the first segment, and marking up in the selected second segment and/or in the selected third segment of at least one part to be parsed; a step 104 of semantic and syntactic parsing of marked-up parts; a step 105 of extracting from the parsed part of the first segment of at least the main entity of the first segment and at least one associative entity associated with the main entity of the first segment, wherein at least one of the extracted associative entities is an associative terminal entity; a step 106 of extracting from each semantically and syntactically analyzed part of the selected second segment and/or selected third segment of at least one statement; a step 107 of associating the statement with the main entity of the first segment.

### BRIEF DESCRIPTION OF DRAWINGS

Potential embodiments of the present invention are described in detail below with reference to the attached drawings, which are included in this document by reference.

FIG. 1 shows (as an example, but not a limitation) an approximate scheme for performing method 100 of automated text processing in natural language.

FIG. 2 shows (as an example, but not a limitation) an approximate diagram of the automated text processing system 200 in natural language.

### DETAILED DESCRIPTION OF THE PREFERRED EMBODIMENTS

In the preferred embodiment of the claimed invention, a method for automated text processing in natural language is provided by the processor of a computer device. This method consists of at least the following stages: identification of text in natural language, including at least three segments; identification of segments; selection of at least the first segment and at least the second segment, and/or at least the third segment of the natural language text; the markup stage in the selected first segment of only one part to be parsed, and the markup stage in the selected second segment and/or in the selected third segment of at least one part to be parsed; semantic and syntactic analysis of the marked parts; extraction from the semantically parsed part of the selected first segment, of at least the main entity of the first segment, and at least the associative entity of the first segment, and at least one of the associative entities is the associative terminal entity; and extracting of at least one statement from each semantically and syntactically parsed part of the selected second segment and/or selected third segment; and the stage of associating the said statement with the said main entity.

In a particular embodiment, the claimed method is characterized by the fact that the first segment, the second segment and the third segment are preliminarily combined to obtain an identifiable text in natural language.

In a particular embodiment, the claimed method is characterized by the fact that the first segment, the second segment and the third segment are preliminarily associated to obtain an identifiable text in natural language.

In a particular embodiment, the claimed method is characterized by the fact that the parsed marked up part in the selected first segment is the first sentence in natural language.

In a particular embodiment, the claimed method is characterized by the fact that each extracted associative entity is subjected to semantic and syntactic analysis and, for each associative entity, at least the main entity of the associative entity is extracted, and at least the nested associative entity connected with the main entity of the associative entity. Moreover, at least one of the nested associative entities is a nested associative terminal entity.

In a particular embodiment, the claimed method is characterized by the fact that the actions are performed iteratively for all nested associative entities, including all associative entities embedded in nested associative entities until the nested associative entity without embedded entity is extracted.

In a particular embodiment, the claimed method is characterized by the fact that the part to be analyzed marked up in the selected first segment is divided into the first part and the second part, then each is subjected to semantic and syntactic analysis.

In a particular embodiment of the present invention, the claimed method is characterized by the fact that the main entity of the selected first segment and all its associative entities are extracted from the first part.

In a particular embodiment, the claimed method is characterized by the fact that at least the main entity is extracted from the second part, and at least an associative essence connected with the main entity of the second part.

In a particular embodiment, the claimed method is characterized by the fact that each extracted associative entity is subjected to semantic and syntactic analysis and, for each associative entity, at least the main entity of the associative entity is extracted, and at least the nested associative entity connected with the main entity of the associative entity. Moreover, at least one of the nested associative entities is a nested associative terminal entity.

In a particular embodiment, the claimed method is characterized by the fact that the actions are performed iteratively for all nested associative entities, including all associative entities embedded in nested associative entities until the nested associative entity without embedded entity is extracted.

In a particular embodiment, the claimed method is characterized by the fact that the main entity of the second part is associated with the main entity of the selected first segment.

In a particular embodiment, the claimed method is characterized by the fact that for each extracted entity, lemmatization is performed at least partially.

In a particular embodiment, the claimed method is characterized by the fact that the markup is carried out using a classification model and/or a clustering model.

In a particular embodiment, the claimed method is characterized by the fact that the separation of the part of the first segment is carried out using a classification model and/or a clustering model.

In another preferred embodiment, a method for forming a text corpus is provided by a computer processor. According to this method, many pairs of texts are obtained, each of which includes at least one statement associated with the main entity of the selected first segment, and a corpus of texts is formed as a result.

In another preferred embodiment, a method for forming a text corpus is provided by a computer processor. According to this method, many pairs of texts are obtained, each of which includes at least one statement associated with the main entity of the selected second part of the first segment, and a corpus of texts is formed as a result.

In another preferred embodiment, a method of pre-training, training, or additional training of the classification model is provided by the processor of a computer device. According to this method, at least, the classification model is trained to classify the text parsing as related to any statement obtained using any of the mentioned methods of text corpus formation. The model receives text parsing classification model containing at least the main entity and at least the associated terminal entity associated with the main entity, while training is carried out using a corpus of texts obtained through any of the mentioned methods.

In another preferred embodiment, a method of pre-training, training, or additional training of the classification model is provided by the processor of a computer device. According to this method, at least, the clustering model is trained to classify the text parsing as related to any statement obtained using any of the mentioned methods of text corpus formation. The model receives text parsing clustering model containing at least the main entity and at least the associated terminal entity associated with the main entity, while training is carried out using a corpus of texts obtained through any of the mentioned methods.

In another preferred embodiment, a method for classifying text parsing is provided by a computer processor. According to his method, at least, a text parsing containing at least the main entity and an associated terminal entity associated with the main entity is fed to the input of the said classification model, and the said text parsing is identified as connected to a statement, obtained using any of the above-mentioned methods of text corpus formation.

In another preferred embodiment, a method for classifying text parsing is provided by a computer processor. According to his method, at least, a text parsing containing at least the main entity and an associated terminal entity associated with the main entity is fed to the input of the said clustering model, and the said text parsing is identified as connected to a statement, obtained using any of the above-mentioned methods of text corpus formation.

In another preferred embodiment, a database generation method is provided by a computer processor. According to this method, a set of text is identified by means of any of the mentioned classification methods, then associated with one or more relevant statements and a database is formed containing at least a set of the mentioned parsed texts, each of which is associated with one or more of the statements.

In another preferred embodiment, a method for generating a database query executed by a computer processor is provided. According to this method, a database query is formed containing at least one statement obtained using any of the mentioned methods of text corpus formation; moreover, the said database contains at least a plurality of parsed texts, each of which is associated with one or more of the mentioned statements.

In another preferred embodiment, a method for selecting text parses is provided by a computer processor. According to this method, at least, a query containing at least some statement obtained using some method of text corpus formation, is generated and sent to the database, and at least, one parsed text associated with the mentioned statement; moreover, the mentioned database contains, at least, many parsed texts, each of which is associated with one or more of the mentioned statements.

In another preferred embodiment, a method for generating a text record is provided by a computer processor. According to this method, at least one statement is obtained using any of the above-mentioned statements, and a syntactically and semantically correct sentence is generated, including the statement or its derivative.

In another preferred embodiment, a method for forming a database with text records is provided by a computer processor. According to this method, at least, a set of text records is obtained by means of the mentioned method of generating text records, and the resulting text records are recorded in the database; the statement is obtained using any of the mentioned methods of text corpus formation.

In another preferred embodiment, a method for generating text in natural language is provided by a computer processor. According to this method, at least, a text record is obtained from a database formed by the above-mentioned method (a database including statements of text records), then a natural language text is generated, including at least the mentioned text record and a text that is not the mentioned record.

In another preferred embodiment of the present invention, a method for generating natural language text executed by a computer processor is provided. According to this method, at least, a natural language text record is identified, including at least the main entity and at least an associative terminal entity, and a statement associated with the main entity; then a text record including this statement is obtained from the database formed with the help of the above-mentioned method, and a natural language text is generated, including at least an identified text record, and a text record obtained from the said database.

In another preferred embodiment, a computer device for automated text processing in natural language is provided, containing at least: a processor; a memory with program code, which (when executed by the processor) prompts the processor to perform actions of any of the mentioned method of automated text processing in natural language.

In another preferred embodiment, a computer device for text corpus creation in natural language is provided, containing at least: a processor; a memory with program code, which (when executed by the processor) prompts the processor to perform actions of any of the mentioned method of text corpus creation.

In another preferred embodiment, a computer device is provided for pre-training, training, or retraining a classification model, containing at least: a processor; a memory with a program code that (when executed by the processor) prompts the processor to perform actions of any of the mentioned methods of pre-training, training, or retraining a classification model.

In another preferred embodiment, a computer device is provided for pre-training, training, or retraining a clustering model, containing at least: a processor; a memory with a program code that (when executed by the processor) prompts the processor to perform actions of any of the mentioned methods of pre-training, training, or retraining a clustering model.

In another preferred embodiment, a computer device for text parsing classification is provided, containing at least: a processor; a memory with program code, which (when executed by the processor) prompts the processor to perform actions of any of the mentioned methods of classifying text parsing.

In another preferred embodiment, a computer device for database creation in natural language is provided, containing at least: a processor; a memory with program code, which (when executed by the processor) prompts the processor to perform actions of any of the mentioned method of database creation.

In another preferred embodiment, a computer device for database query generation in natural language is provided, containing at least: a processor; a memory with program code, which (when executed by the processor) prompts the processor to perform actions of any of the mentioned methods of database query generation.

In another preferred embodiment, a computer device for text parsing selection is provided, containing at least: a processor; a memory with program code, which (when executed by the processor) prompts the processor to perform actions of any of the mentioned methods of text parsing selection.

In another preferred embodiment, a computer device for text record generation is provided, containing at least: a processor; a memory with program code, which (when executed by the processor) prompts the processor to perform actions of any of the mentioned methods of text record generation.

In another preferred embodiment, a computer device for database creation with text records statements is provided, containing at least: a processor; a memory with program code, which (when executed by the processor) prompts the processor to perform actions of any of the mentioned methods of database creation with text records statements.

In another preferred embodiment, a computer device for text generation in natural language is provided, containing at least: a processor; a memory with program code, which (when executed by the processor) prompts the processor to perform actions of any of the mentioned methods of text generation in natural language.

In another preferred embodiment, a machine-readable data carrier is provided, including a non-transitive machine-readable data carrier containing program code that prompts the processor to perform actions of any of the mentioned methods, when executed by the processor.

The embodiments of the claimed invention are given below, revealing examples of its implementation. However, the description is not intended to limit the scope of the rights granted by this patent. Rather, it should be assumed that the claimed invention can also be implemented in other ways so that it will include different elements and conditions or combinations of elements and conditions similar to the those described in this document in combination with other existing and future technologies.

A patent document, as described here, is not limited to a patent or patent application, which is typically a specific text consisting of at least three segments: the first segment, which is patent claims, the second segment, which is a description, and the third segment, which is an abstract, the numbering of the segments above is not given in order in the natural language text, but only for simplicity of presentation and association in this document, as will be shown below. Preferably, without limitation, claims of patent documents do not apply to new chemical compounds and other similar objects created for the first time, since in relation to such objects, the statement of a technical result does not require identification.

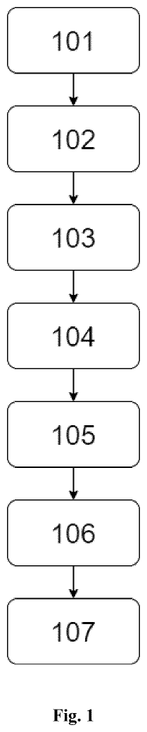

FIG. 1 shows (as an example, but not a limitation) an approximate scheme for performing method 100 of automated text processing in natural language. Method 100 consists of at least the following stages: identification of text in natural language 101, including at least three segments; identification of segments 102; selection 103 of at least the first segment and at least the second segment, and/or at least the third segment of the natural language text; the markup stage in the selected first segment of only one part to be parsed, and the markup stage 104 in the selected second segment and/or in the selected third segment of at least one part to be parsed; semantic and syntactic analysis 105 of the marked parts; extraction 106 from the semantically parsed part of the selected first segment, of at least the main entity of the first segment, and at least the associative entity of the first segment, and at least one of the associative entities is the associative terminal entity; and extracting of at least one statement from each semantically and syntactically parsed part of the selected second segment and/or selected third segment; and the stage 107 of associating the said statement with the said main entity. For example, without limitation, during the natural language text identification stage 101, reliable identification of the natural language text is provided, such as a patent document. For example, without limitation, segments of a patent document can be represented by separate texts in natural language, for which, if necessary, they are previously associated, for example, by assigning them unique identifiers. The decryption of those identifiers allows to determine the connectedness of segments. Such methods of associating entities in data storage systems are widely known from the state of the art and are not described in detail further. For example, without limitation, a patent document may be a single text, usually with end-to-end page numbering; in this case, preliminary association of segments with each other is not required.

Preferably, without limitation, during stage 102, identification of natural language segments is provided; for example, when the natural language text is a patent document, identification of at least the patent claims, which is the first segment in the context of the present invention; the description, which is the second segment, and the abstract, which is the third segment in the context of the present invention. If the natural language text is not a patent document, the identification of segments is carried out in a similar way. It should be clarified that the first segment includes a set of entities, while the second and third segments include at least one or more statements specific to the said set of entities. An example of a suitable non-patent document may be, for example, without limitation, a scientific article in which the abstract may be the first segment, and the main text and the conclusion may be the second and third segments respectively.

Preferably, without limitation, during stage 103, the selection of identified segments is carried out; the selection of the first segment, as including a set of entities, and either the second segment or the third segment is necessarily carried out. The choice as to which segment should be selected depends on the probability with which the statement will be present in a particular segment. More specifically, but not limited to, the presence of a statement in a particular segment will generally depend on the requirements to a natural language text. For example, if the natural language text is a patent document, then depending on the patent system, the third segment (abstract) will contain at least a statement about the technical result. For example, patent documents of the Russian Federation, as a rule, are published with an abstract in which the technical result is given. Moreover, the abstract is prepared by an expert group, which is competent in the relevant technical field, which excludes inaccuracies in the technical result description. In US patent documents, the abstract is usually prepared by the applicant himself or herself, which leads to the fact that the abstracts in US patent documents do not have a clear structure, and the technical result description is not guaranteed. Thus, for example, without limitation, when choosing between the second segment and the third segment in the US patents, it will be more effective to choose the second segment, since at least in the sections Background of the Invention or Brief Summary of Invention, there is a high probability that there will be a statement about the technical result, as required by MPEP 608.01(c) and 608.01(d). For example, without limitation, for each natural language text, a segment can be selected based on the presence of the statement. For this, for example, without limitation, semantic and syntactic analysis can be performed for each text in a natural language, using a semantic parser, which is widely represented in the state of the art and is not described further; according to the results of semantic and syntactic analysis, it becomes possible to determine a specific part of the text in a natural language, containing the desired statement. Preferably, without limitation, the first segment is preliminarily excluded from the natural language text, as it obviously does not have statements, and its presence in semantic and syntactic analysis may distort the results.

Preferably, without limitation, during step 104, the parts in the selected segments are marked. Preferably, without limitation, only one part to be analyzed is marked in the selected first segment, namely, the part that contains a set of entities. For example, if the natural language text is a patent document, the first paragraph of the claims section is selected as the marked part as most likely having the required set of entities, that is, a set of essential features. Also, there are situations when the totality of entities (features) in the first paragraph of the claims, in addition to essential features, also includes non-essential features. In this case, the selected first segment can be subjected to additional analysis after finding the technical result statement in the second or third segment and checking which criteria do not affect the achievement of the technical result; according to such analysis, the marked part is cleared of unnecessary entities. In this case, preferably, without limitation, the marked and optionally cleared part of the selected first segment can be analyzed in order to determine the presence of a generic part (first part) and a distinctive part (second part) in it; in this case, for such an analysis it may be sufficient to determine the word-bundle separating the generic part from the distinctive part. Not every patent system prescribes that an independent claim must be drawn up using a distinctive part, which leads to the fact that the generic part is not explicitly highlighted and not cut off by a linking word; in this case, a preliminary semantic and syntactic analysis of the entire first segment can be carried out in order to identify at least the main entity of the first segment and the main entities associated with the main entity of the first segment, which will be discussed in detail later. As a rule, without limitation, when the text in natural language is a patent document, a generic concept will be defined as the main entity, and individual features, for example, stages of methods or parts of products, will be identified as associated entities; the resulting set of the main entity and associated entities can be analyzed, then it can be determined that either the whole set is generic, or only some features are generic. The frequency analysis can be performed automatically, based on a previously prepared corpus of texts, in which the first segment was defined and a semantic and syntactic analysis was carried out in relation to the part to be analyzed. The separation can be carried out both manually and automatically, for example, using a pre-trained classification model and/or clustering model. The markup in the selected second segment or in the selected third segment is carried out in such a way as to obtain the desired statement with the highest probability. Usually, the presentation of the desired statement is preceded by a certain text structure, or the presentation of the desired statement includes certain keywords. Several parts of the selected second segment or the selected third segment can be marked up in this way. The markup can be carried out both manually and automatically, for example, using a pre-trained classification model and/or clustering model. Preferably, without limitation, during stage 105, the marked-up parts are parsed semantically and syntactically using the mentioned syntactic parser or other means.

Preferably, without limitation, during stage 106, at least the main entity of the first segment is extracted from the parsed parts of the first segment, and at least an associative entity from the main entity of the first segment, and at least one of the extracted associative entities is an associative terminal entity. For example, if the first segment is patent claims, the first independent clause of the formula will be subjected to semantic and syntactic analysis; in this case, the main entity will be the generic concept, which is the root of the parsing tree, the associative entities will be the elements of a technical solution, which are nodes of the parsing tree, and, at least, one associative entity will be an associative terminal entity, that is, it will be a feature with only one edge: it will be the end node (leaf) of the parsing tree. The parsing tree can be built on the principle of an abstract syntax tree (AST), that is, it can be cleared of all non-essential features, repetitions, anaphors and other elements that do not affect the statement, so they cannot influence the technical result. An example of non-essential elements obtained after parsing would be, but not limited to, a comma or other separator, which are useful during parsing as links or boundaries, but are non-essential for the text corpus when used, for example, to train a classification model and/or clustering model. In addition, when the first segment is divided into generic and distinctive parts, the main entity of the first segment will be found in the first/generic part, along with the entities associated with it from the generic part; the second/distinctive part will contain the main entity of the second part and the entities associated with it, which are also all associated with the main entity of the first segment, since all the individual elements identified through analysis directly or indirectly belong to only one generic concept. In this case, for example, without limitation, each associative entity extracted in this way can be iteratively subjected to a semantic and syntactic analysis, during which the corresponding main entities of the associative entities and associative entities of the associative entities will be discovered, that is, each associative entity can have many nested associative entities up to one or more associative terminal entities that can no longer be subjected to semantic and syntactic analysis, since they are too simple. In this case, lemmatization can be carried out to bring words to their standard forms. For each entity, including the main entity, and any associative entities, a generalization operation can be performed in which the entity can be elevated to the level of a method or product that corresponds to a certain function determined by the characteristics of the entity. Preferably, at least one statement is extracted from each semantically and syntactically analyzed part of the selected second segment and/or selected third segment. For example, if the natural language text is a patent document, after semantical and syntactical parsing of paragraph 0010 in this description, two statements (“accurate formation of the texts corpus” and “automated formation of the texts corpus”) will be obtained. During the semantic and syntactic analysis of paragraph 0011, three statements can be obtained: “the purpose implementation is the formation of a corpus”, “accurate formation of a corpus of texts” and “automated formation of a corpus of texts”. During stage 107, at least one extracted statement is associated with the main entity of the first segment, and thus the statement is associated with any associative entities connected with the main entity of the first segment. Some of the statements, such as “purpose implementation”, are of no practical use, since they cannot subsequently be used as part of a corpus to train a classification model and/or a clustering model in order to predict a statement corresponding to a new set of entities, since this will lead to the fact that any classifier based on the classification model and/or clustering model will attribute any set of entities to such a statement, since such a statement is present in all received parses of the text. For this reason, the received pairs (statement-main entity) are cleared to remove unnecessary statements.

Thus, preferably, it becomes possible to obtain a corpus of texts by means of the said method 100. At stage 107, by associating the said statement with the main entity of the first segment (and, as a result, with all associative entities of the main entity), many pairs of texts are obtained, each including at least one statement related to the main entity of the first segment. A corpus is formed from the received pairs of texts. Alternatively, it is possible to obtain a corpus of texts by means of the mentioned method 100 at stage 107 by associating the said statement with the main entity of the second part marked up in the first segment of the part to be parsed (and, as a result, with all associated entities associated with the main entity of the second part marked up in the first segment); then a set of text pairs is received, each including at least one statement related to the main entity of the second part marked in the first segment. A corpus is formed from the received pairs of texts. The resulting text corpus can be used both jointly and separately, for pre-training, training, or retraining a classification model and/or clustering model. Such models are trained to classify text parsing as related to any of the mentioned statements; when entering a classification model and/or clustering model for parsing a text contains at least the main entity and an associative terminal entity associated with the main entity, while training is carried out on one of the mentioned text corpus, jointly or separately. Without limiting, the main entity is understood as the main entity of the first segment or the mentioned main entity of the second part of the first segment to be analyzed. To train a classification model and/or clustering model a sample from the corpus of texts is provided, then a classification model and/or clustering model is trained on that sample. The classification model is based on one of the following methods: logistic regression, support vector method, decision tree method, random forest method, naive Bayes classifier, k-nearest neighbor method, neural network, boosting, gradient boosting, bagging, group accounting of arguments, etc. The clustering model is based on one of the following methods: k-means method, density-based spatial clustering of applications with noise (DBSCAN), hierarchical clustering method, spectral clustering method, etc. Any suitable known or future-known classification model and/or clustering model can be used, the choice of one should proceed from the fact that such a model provides for the possibility of obtaining the same weights for different statements. This is mainly due to the fact that several different statements may correspond to the same parsing of the text. For example, without limitation, the same invention with the same set of essential features, can achieve different technical results, each of which may be suitable and lead to a solution to its own technical problem. This happens due to the fact that a technical problem is formulated in relation to certain state of the art, or even a prototype. In this regard, it is preferable that the classification and clustering model used make it possible to classify text parsing as corresponding to several statements at once. Moreover, the weights of statements do not necessarily have to be the same in order to make a decision on attributing text parsing to these statements; in fact, attributing text parsing to several statements at once can be ensured by determining the permissible proximity of the weights.

Thus, when an appropriate classification model or clustering model is obtained, it becomes possible to provide a text parsing classification method in which, at least, a text parsing containing at least the main entity and an associative terminal entity associated with the main entity is fed to the input of the resulting classification model and/or clustering model. Then the text parsing is classified as related to any mentioned statement obtained using any mentioned method of text corpus formation. Without limiting, the main entity is understood as the main entity of the first segment or the mentioned main entity of the second part of the first segment to be analyzed.

The classified text parses can subsequently be stored in the database of the natural language automated text processing system 200, which will be described in detail below with reference to FIG. 4. For this purpose, a method of forming a database is provided in which a set of the mentioned classified text parses is identified, associated with one or more relevant statements and a database is formed containing at least a set of the mentioned text parses, each of which is associated with one or more of the mentioned statements. It becomes possible to obtain parses of texts that correspond to any statement selected by the user. Preferably, for this purpose a method for generating a database query executed by a computer processor is provided. According to this method, a database query is formed containing at least one statement obtained using any of the mentioned methods of text corpus formation; moreover, the said database contains at least a plurality of parsed texts, each of which is associated with one or more of the mentioned statements. For example, a query may be provided containing the statement “accurate formation of the corpus of texts”, in response to which at least one relevant text parse will be selected. However, depending on the statement, too many parses may be selected, which may make the query irrelevant. In order to increase the query's relevance, it can be supplemented with an additional statement, which will inevitably reduce the resulting sample of text parses. Thus, preferably, a method for selecting text parses is provided by a computer processor. According to this method, at least, a query containing at least some statement obtained using some method of text corpus formation, is generated and sent to the database, and at least, one parsed text associated with the mentioned statement; moreover, the mentioned database contains, at least, many parsed texts, each of which is associated with one or more of the mentioned statements.

The obtained result provides new possibilities for generating texts in natural language, in particular, but not limited to, descriptions of patent documents. A method of generating a text record is provided in which at least one statement is obtained using any of the mentioned methods to form text corpus, and a syntactically and semantically correct sentence is generated, including the statement or its derivative. A text record is understood as a part of text, but not the entire text, and the text is understood as a set, including heterogeneous text records. The mentioned statement may exist in the generated text record both unchanged and in the form of a derivative, that is, after being subject to modifications in order to ensure the generated sentence consistency. The received text records can be placed in a database of text records, containing a statement. To do that, a method for forming a database of text records with a statement is provided. According to this method, at least, a set of text records is obtained by means of the mentioned method of generating text records, and the resulting text records are recorded in the database; the statement is obtained using any of the mentioned methods of text corpus formation. For example, such a database can subsequently be used as a source of standardized records when generating natural language text. To do that, a method for generating text in natural language is provided. According to this method, at least, a text record is obtained from a database formed by the above-mentioned method (a database including statements of text records), then a natural language text is generated, including at least the mentioned text record and a text that is not the mentioned record. For example, text, that is not the mentioned statement, may be entered by the user. Thus, a method for generating natural language text is provided. According to this method, at least, a natural language text record is identified, including at least the main entity and at least an associative terminal entity, and a statement associated with the main entity; then a text record including this statement is obtained from the database formed with the help of the above-mentioned method, and a natural language text is generated, including at least an identified text record, and a text record obtained from the said database. The identified record may represent a text entry made by the user. More particularly, the text entry made by the user is a syntactically and semantically correct sentence. More particularly, the entry is an independent paragraph of the patent claims. Thus, text in natural language is generated, based on the text entered by the user and including a part of the text that the user does not actually enter, that is, which is generated automatically. The text generation is carried out by methods and means known from the state of the art, such as, for example, NLP processors, which are not described in detail further.

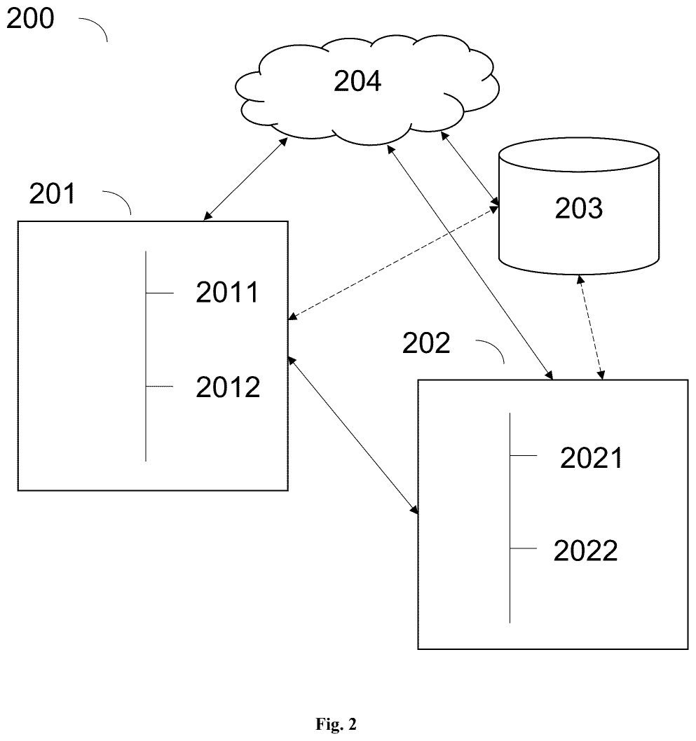

Thus, preferably, but not limited to, as shown in FIG. 2, a computer device 201 can be provided with at least one element or any combination of the following: a computer device for automated text processing in natural language, a computer device for generating corpus of texts, a computer device for pre-training, training, or retraining a classification model, a computer device for pre-training, training, or retraining a clustering model, a computer device for classifying text parsing, a computer device for forming a database, a computer device for forming a query to a database, and a computer device for selecting text parsing. Such a computer device 201 usually contains at least one processor 2011; memory 2012 containing the program code, which, when executed by the processor 2011, prompts the processor 2011 to perform the actions of any of the aforementioned methods described with reference to FIG. 1. Namely methods of automated text processing in natural language, and/or a method for forming a corpus, and/or a method of pre-training, training, or retraining a classification model, and/or a method of pre-training, training, or retraining a clustering model, and/or a method of classifying text parsing, and/or a method of forming a database, and/or a method of forming a query to a database, and/or a method for selection of text parsing. A computer device can be implemented as a thin client, which will mean that all, or at least most, computing operations are performed on the system server 202, which also contains at least a processor 2021 and memory 2022, which are essentially similar to the processor 2011 and memory 2012. As an example, but not a limitation, memory 2012, 2022 (machine-readable storage medium 2012, 2022) may include non-volatile memory (NVRAM); random access memory (RAM); permanent storage device (ROM); electrically erasable programmable permanent storage device (EEPROM); flash memory or other memory; CDROM, digital versatile disk (DVD) or other optical or holographic data carriers; magnetic cassettes, magnetic film, magnetic disk storage device or other magnetic storage devices; and any other data carrier that can be used to store and encode the required information. Memory 2012, 2022 includes a data carrier based on a computer storage device in the form of volatile or non-volatile memory, or a combination thereof. Hardware devices may include solid-state memory, hard disk drives, optical disk drives, etc. The machine-readable data carrier 2012, 2022 (memory 2012, 2022) is not temporary (permanent, non-transitive), so it does not include a temporary (transitive) propagating signal. An environment can be stored in memory 2012, 2022, a procedure for automated text processing in natural language, and/or a procedure for forming a corpus of texts, and/or a pre-training procedure can be carried out, training, or retraining of the classification model, and/or the procedure for pre-training, training, or retraining of the clustering model, and/or the procedure for classifying text parsing, and/or the procedure for forming a database, and/or the procedure for forming a query to the database, and/or the procedure for selecting text parsing. If not a thin client, the computer device 201 contains one or more processors 2011, which are designed to execute computer commands stored in the memory 2012 of the device 201 in order to execute the above-mentioned procedures. The server 202 can essentially be similar to a computer device 201 (if not a thin client) and contain one or more processors 2021, which are designed to execute computer commands or codes stored in the memory 2022 of the server 202 in order to execute the above-mentioned procedures. The system 200 may also include a database (DB) 203. DB 203 may be represented as follows: a hierarchical database, a network database, a relational database, an object database, an object-oriented database, an object-relational database, a spatial database, a combination of these two or more databases, etc. DB 203 stores classified text parses associated with relevant statements, and can also store data for analysis, classification models, clustering models and other information in memory 2021, 2022 or in suitable memory of another computer device associated with computer device 201 and/or with server 202, which may be, but not limited to, memory similar to 2021 and 2022, as previously shown, and which can be accessed via server 202. In addition, a server 202 is provided, which also stores and facilitates the execution of computer commands previously described in this document. In addition to the functions described earlier, the server 202 can manage data exchange in the system 200. Moreover, data exchange within the system 200 is carried out through one or more data transmission networks 204. Data transmission networks 204 may include, but not limited to, one or more local area networks (LAN) and/or wide area networks (WAN), or may be represented as Internet, Intranet, or virtual private network (VPN), or a combination thereof, etc. The server 202 also has the ability to provide a virtual computing environment to ensure interaction between system components. The network 204 can provide communication between the computer device 201, the server 202, and the database 203 optionally. The computer device 201 and/or a server 202 can be connected to the database 203 directly using wired and wireless communication methods known from the state of the art, which are not described in detail further. Database 203 can also be implemented in memory 2012, 2022. A suitable non-thin client computer device 201 can act as a server 202 of the system 200 for other computer devices 201 that are thin clients. Usually, the computer device 201 components and server 202 components are interconnected through some kind of data bus.

The present description of the claimed invention contains only particular embodiments and does not limit other embodiments of the claimed invention, since other possible embodiments of the claimed invention, that do not go beyond the scope, should be obvious to a specialist in this field of technology for whom the claimed invention is designed.

1. A method for generating a request to a database, the method executed by a processor of a computer device, the method for generating a request to a database comprising: forming the request to the database containing at least one statement obtained using a method of forming a text corpus, wherein the database contains at least a plurality of parsed texts, each associated with one or more of said statements,
wherein the plurality of parsed texts being obtained using a method executed by a processor of a computer device, the method comprising: obtaining a plurality pairs of texts using a method of automated processing of natural language text, wherein each pair includes at least one statement associated with a main entity of a first segment, and forming the text corpus from the resulting pairs of texts;
wherein the method of automated processing of natural language text being executed by a processor of a computer device, the method of automated processing of natural language text comprising at least the following steps:
a step 101 of identification of a natural language text with at least three segments;
a step 102 of identification of segments;
a step 103 of selecting of at least the first segment and at least a second segment and/or at least a third segment of the natural language text;
a step 104 of marking up of only one part to be parsed in the first segment, and marking up in the selected second segment and/or in the selected third segment of at least one part to be parsed;
a step 105 of semantic and syntactic parsing of marked-up parts;
a step 106 of extracting from the parsed part of the first segment of at least the main entity of the first segment and at least one associative entity associated with the main entity of the first segment, wherein at least one of the extracted associative entities is an associative terminal entity;
and extracting from each semantically and syntactically analyzed part of the selected second segment and/or selected third segment of at least one statement;
a step 107 of associating the statement with the main entity of the first segment.

2. The method according to claim 1, characterized in that the first segment, the second segment and the third segment are preliminarily combined to obtain the natural language text.

3. The method according to claim 1, characterized in that first segment, the second segment and the third segment are preliminarily associated to obtain the natural language text.

4. The method according to claim 1, characterized in that the marked-up part to be parsed in the first segment is the first natural language sentence.

5. The method according to claim 4, characterized in that each extracted associated entity is subjected to semantic-syntactic parsing and at least the main entity of the associated entity and at least a nested associated entity associated with the main entity of the associated entity are extracted for each associated entity, wherein at least one of the nested associated entities is a nested associated terminal entity; wherein actions of the method according to claim 5 iteratively performed for all nested associated entities, including all associated entities nested in nested associated entities until a nested associated entity is extracted in which no entity is nested.

6. The method according to claim 1, characterized in that the part to be parsed in the first segment is divided into two parts, then each part is subjected to semantic and syntactic parsing; the main entity of the first segment and all associative entities connected with it are extracted from the first part; the main entity of the second part, and at least an associative entity connected with the main entity of the second part is extracted from the second part.

7. The method according to claim 6, characterized in that each extracted associated entity is subjected to semantic-syntactic parsing and at least the main entity of the associated entity and at least a nested associated entity associated with the main entity of the associated entity are extracted for each associated entity, wherein at least one of the nested associated entities is a nested associated terminal entity; wherein actions of the method according to claim 7 iteratively performed for all nested associated entities, including all associated entities nested in nested associated entities until a nested associated entity is extracted in which no entity is nested.

8. The method according to claim 7, wherein the main entity of the second part is associated with the main entity of the first segment.

9. The method according to claim 1, wherein at least one extracted statement is deleted before forming a text corpus.
